(19) United States
(12) Patent Application Publication
(10) Pub. No.: US 2006/0265941 A1
(43) Pub. Date: Nov. 30, 2006

(54) Pest detection apparatus

(76) Inventor: John Newton, West Sussex (GB)

Correspondence Address: CASELLA & HESPOS, 274 MADISON AVENUE, NEW YORK, NY, 10016, US

(21) Appl. No.: 10/575,643

(22) PCT Filed: Oct. 13, 2004
(86) PCT No.: PCT/GB04/04356

§ 371 Date: May 30, 2006

(30) Foreign Application Priority Data
Oct. 14, 2003 (GB) 0324060.3

(51) Int. Cl. A01M 23/00; A01M 1/14; A01M 1/10; A01M 23/16

(52) U.S. Cl. 43/58; 43/114; 43/60

(57) ABSTRACT

The present invention provides for pest detection apparatus which signals the detection of a pest and subsequently retains the pest for the purpose of inspection and which includes an entrapment portion (42) accessible via an entrance portion (34) such that detection means detects the presence of a pest in the region of the entrapment portion (42) and which apparatus is likely to be most effective in capturing small animals of the phylum Arthropoda but may similarly be used with other small pests such as rodents.

The present invention relates to pest detection apparatus and in particular to an arrangement which seeks to both detect and retain a pest so that it can be subsequently inspected.

Such apparatus is commonly used for pest control and as part of a pest control service.

In providing a pest control service, a contractor is generally required to provide regular service visits to a client's site in order to inspect for the presence of any pests and to carry out any pest control measures found to be necessary. As an example a technician might normally visit a client once every four to eight weeks for this purpose although a substantial number of these visits may result in no further pest control measures being required.

In the event that evidence of pest activity is discovered during the interval between service visits, a client may have the option to request an additional visit from a technician in order to address the problem. However, especially in premises which are not continuously occupied or continually inspected, a pest could conceivably be at large and undetected for some time between routine visits. This is particularly disadvantageous since even a relatively temporal incidence of pests has the potential of causing severe problems such as the spreading of disease or otherwise damaging the client's business.

The present invention seeks to provide for pest detection apparatus having advantages over known such apparatuses. Further, there exists an opportunity for a contractor to improve the level of service offered by using a device which detects the presence of pests on a client's premises and automatically alerts either the client or the contractor. A technician can be sent out in direct response to a detection and thus the period during which the pest is at large can be considerably reduced.

It is a yet further aim of the present invention to increase the efficiency of the detection and control of pests. It will be understood that by employing a device to signal detection of a pest, it is possible for the contractor to reduce the number of unnecessary inspection visits without increasing the likelihood that the presence of pests will go unnoticed. Furthermore the task of inspecting an entire premises may be reduced to the inspection of a number of pest detection apparatus and the time and effort expended by the contractor may be decreased.

Especially in the case of insect pests, it may not be evident which specific type of pest is present. The effective control of different types of insects requires different measures to be taken and so, upon being called out by a client, a technician may be required to carry out an inspection in order to try to determine which of a range of control measures is most suitable. Such a situation is prevalent when a pest has been seen by a client or detected by a device and has subsequently evaded capture. Hence the present invention seeks to offer particularly effective pest detection apparatus by providing means for increasing the probability of accurately detecting and trapping any pest which enters the detection device.

According to the present invention there is provided pest detection apparatus comprising, an entrance portion, an entrapment portion accessible via the entrance portion, detection means for detecting the presence of a pest once in the region of the entrapment portion, means for indicating detection of a pest by the detection means, and inspection means arranged to allow for viewing of a trapped pest.

Advantageously the entrance portion may be arranged to guide a pest towards the entrapment portion.

According to a preferred embodiment the apparatus includes a surface portion disposed between the entrance portion and the entrapment portion such that a region of the surface portion may alternatively be arranged, either to encourage a pest to traverse thereover, or to discourage a pest from traversing thereover.

Preferably the entrance portion leads to a tunnel member, such that at least one region of the tunnel member has a roughened surface texture and/or at least one region of the tunnel member has a smooth surface texture. The frictional properties of the smooth surface serve to offer minimal grip to a pest and thus discourage it from attempting to cross thereover, whilst the rough surface conversely encourages a pest to cross thereover by offering ample grip.

Providing a tunnel-shaped entrance portion in this manner is advantageous in that a pest can unwittingly be guided along a particular path in order to increase the chance that it will access the entrapment portion in such a manner as to be acutely susceptible to entrapment. Since this manner of operation relies on the natural intuition of the pest it is further beneficial that the probability of trapping a pest is increased without the need to employ any potentially costly features such as, for example, further mechanical parts.

Optionally the entrapment portion comprises an adhesive material provided with an adhesive coated surface. Advantageously the adhesive material may be removably and replaceably positioned within the entrapment portion.

The adhesive material may be provided as an adhesive surface on a removable thin flat member, such as a card member, and preferably the adhesive material comprises a glue.

Preferably the detection means and the means for indicating detection are provided in separate housings, and electrical connection between the two housings is achieved by means of a connecting wire.

In this manner, the on-board power supply for the apparatus can be located within the housing of the said means for indicating detection of a pest.

Further, at least the majority of the control electronics are provided within the housing for the means for indicating detection of a pest.

Antenna means can be provided mounted to the housing for the means for indicating detection of a pest and for the transmission of a signal to remote device for monitoring detection, and/or for monitoring system status such as battery condition, pre-armed test state or armed state.

Preferably, the apparatus can include a removable locating frame member for engaging the entrapment portion within the apparatus.

The locating frame member can advantageously be arranged to secure the entrapment portion within the apparatus. Also, the locating frame can include a plurality of downwardly depending leg members arranged to engage the entrapment portion.

The said leg members can be arranged so as to at least assist in guiding the adhesive material to the entrapment portion.

Preferably the locating frame includes openings to enhance the visibility of the entrapment portion, and so the locating frame can comprise a lattice frame member. The locating frame can also include formations serving to shield the detection arrangement from stray radiation.

As will be appreciated, the entrapment portion can comprise a flat foldable member in which a first portion is foldable relative to a second portion.

In particular, the adhesive material can be provided on a first portion, and a window is formed within the second portion such that when the second portion is folded onto the first portion, the adhesive material is exposed through the said window.

Advantageously the portion of the flat foldable member defining said window is provided with a surface arranged to prevent escape of the pest once it has encountered the adhesive material. Such surface is advantageously relatively smooth and slippery.

Preferably the flat foldable member comprises a card member.

According to another aspect of the invention there is provided a pest entrapment member for use within pest monitoring apparatus comprising a flat member having first and second portions separated by a fold line allowing for folding of the second portion onto the first portion, wherein the first portion is provided with an adhesive material, and the second portion is provided with a window such that, upon folding of the second portion onto the first portion, the adhesive material is exposed via the said window.

The entrapment portion may alternatively comprise a mechanical trap.

According to one embodiment of the present invention, the detection means may comprise at least one emitter/detector pair, which may optionally be arranged such that the path of radiation extending between the emitter/detector is interrupted by a pest.

Further the at least one emitter/detector pair may be mounted relative to the entrapment portion such that a pest is detected once the pest has passed sufficiently far over the periphery of the adhesive material to make it unlikely that it will retrace its steps and escape.

The radiation may optionally comprise an infrared beam.

The alerting means may usefully be activated when the radiation beam is broken.

As will be appreciated, the positioning of at least one emitter/detector pair in such a manner relative to the entrapment means allows for an advantageously simple and cost-effective means of achieving an increase in the likelihood of retaining and detecting a pest, as opposed to detecting a pest without retention.

Preferably the means for indicating the detection of a pest is arranged to provide a signal which may be audible and/or visible, or a data signal which can be arranged to be transmitted to a remote location.

Optionally the inspection means may be transparent or, according to an alternative embodiment, the inspection means may comprise a movable portion of the pest detection apparatus, which is movable to allow for the aforesaid inspection.

The provision of alerting means combined with appropriate inspection means advantageously allows even an unskilled operative to monitor and inspect the apparatus.

Furthermore the occurrence of a situation whereby a technician is called out to a client but is not then able to identify the required treatment, or whereby an inspection is required to find out the type of pest at hand, causes wasted time and resources and is clearly inconvenient to both the client and the contractor. Therefore, in addition to increasing the chance of trapping a pest, it is a further favourable attribute of the present invention that the chance of detecting a pest without retaining it, is less than the chance of retaining a pest without detecting it. In the latter of these situations, a technician would be able to check an apparatus as part of a routine visit, as opposed to being called out by the client, and quickly identify what type of pest is present in order to select an appropriate control measure, with a minimal disruption to the client's business.

The detection apparatus is further beneficial in providing for a cost-effective and re-usable means for identifying the presence of a pest. Such simplistic detection and entrapment means are made effective by guiding a pest to the entrapment portion in a predictable manner.

The above aspects of the present invention are all advantageous in that the pest detector apparatus comprises a relatively small and readily portable device which can be easily positioned in any particular location and transferred as required between different locations without requiring connection to an external power source.

The invention is described hereinafter, by way of example only, with reference to the accompanying drawings in which:

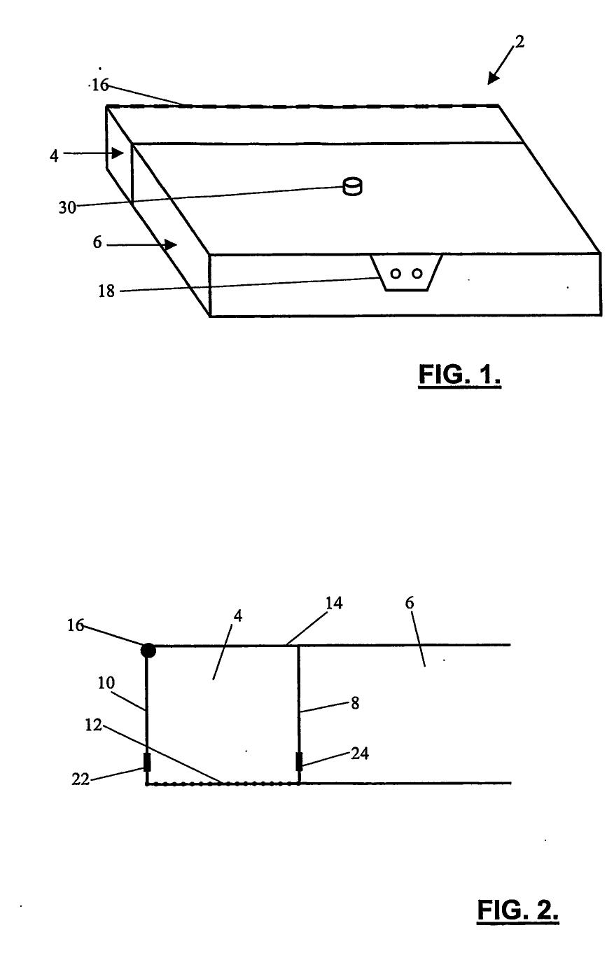

FIG. 1 is a perspective view of pest detector apparatus embodying one aspect of the present invention;

FIG. 2 is a side view of a tunnel member of the embodiment of FIG. 1;

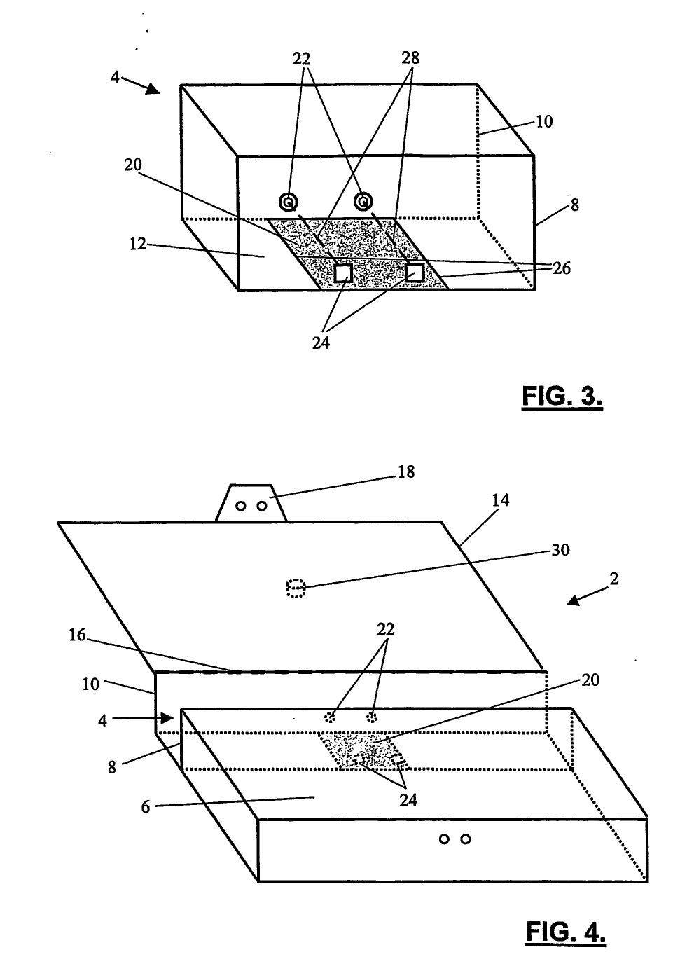

FIG. 3 is a perspective view illustrating one region of the tunnel member of FIG. 2;

FIG. 4 is a perspective view of pest detection apparatus embodying one aspect of the present invention with the lid pivoted into an open position;

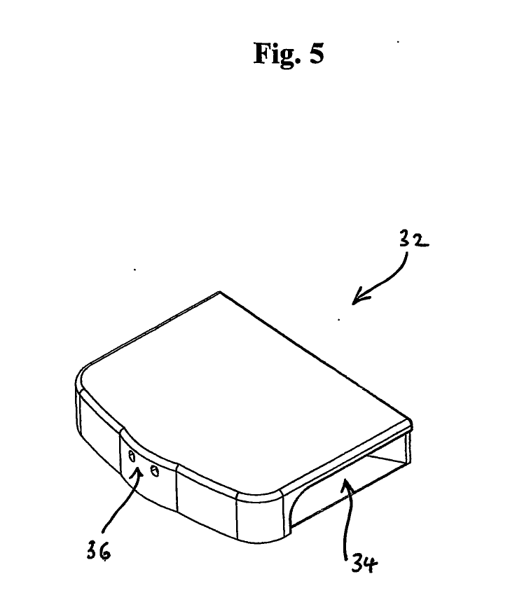

FIG. 5 is a perspective view of a pest detection apparatus according to another embodiment of the present invention;

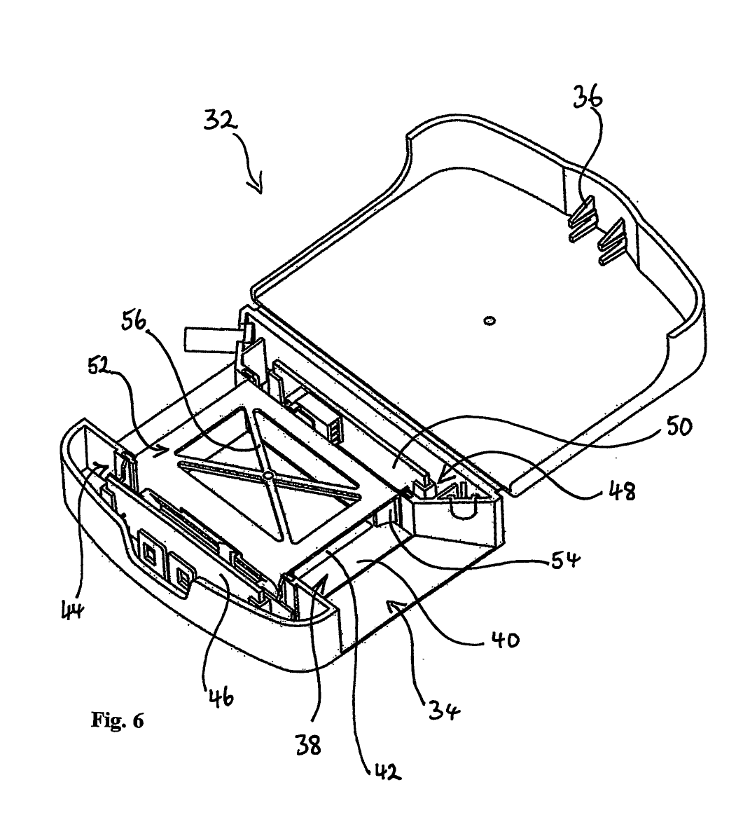

FIG. 6 is a perspective view of the apparatus of FIG. 5 but with the lid pivoted to an open position;

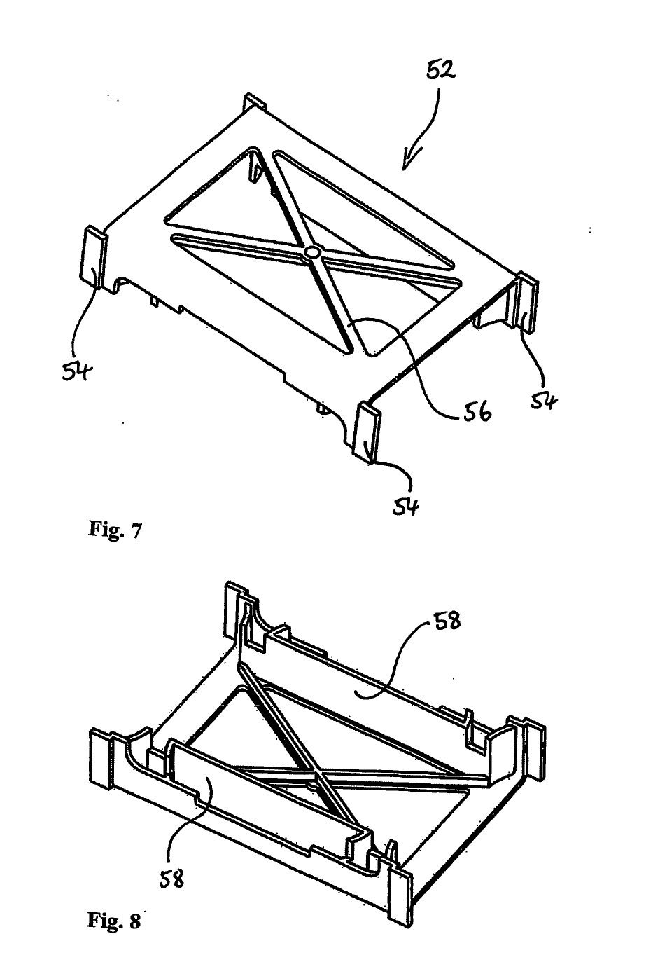

FIG. 7 is a perspective view of one embodiment of a locating frame arranged for use within the present invention and as also illustrated in FIG. 6; and

FIG. 8 is an underside perspective view of another embodiment of a locating frame.

With reference to FIGS. 1-3 of the drawings, there is illustrated one particular embodiment of a pest detection apparatus 2 according to one aspect of the present invention in which a tunnel section 4 of substantially rectangular cross-section is positioned adjacent to a compartment 6 such that both the tunnel section 4 and the compartment 6 share a common inner wall 8. An outer wall 10, a floor 12 and a section of the lid 14 enclose the tunnel section 4, which is open-ended.

The lid 14 is attached by hinges 16 to the outer wall 10 and extends such that it also completely covers the compartment 6 when in the closed position as shown in FIG. 1. A catch 18 may be used to secure the lid 14 in the closed position which, when released, allows the lid 14 to pivot about the hinges 16 into an open position so as to expose the tunnel section 4 and the compartment 6, as shown in FIG. 4. A special key, such as a two pronged key, may optionally be required to unlock the catch 18 so that the pest detection apparatus 2 can be made ‘tamper-resistant’.

The floor 12 of the tunnel section 4 has a rough finish whilst the other three surfaces enclosing the tunnel section 4, as defined by the inner wall 8, the outer wall 10 and a portion of the lid 14, all have a very smooth, polished finish.

Positioned within the tunnel section 4 is an entrapment arrangement illustrated with reference to FIG. 3, comprising an adhesive-coated card 20 which serves to cover the central region of the tunnel floor 12. An adhesive coating covers the upper surface of the card 20 and so extends at right angles between the inner wall 8 and the rear wall 10 of the tunnel. Mounted on the rear wall 10 above the adhesive-coated card 20 are two infrared emitters 22, facing two corresponding infrared detectors 24 on the inner wall 8.

Within the present invention, the radiation beam sent from the emitters 22 to the detectors 24 can comprise a pulsed beam which is switched on and off, for example, at least once per second, and so as to save power, and therefore extend battery life. The detection system is in this manner placed in an “off” mode for a sufficient amount of time to achieve such power saving. Providing for such a pulsed beam also allows the system to reset itself to small changes in radiation detected by the receiver and to prevent triggering that might otherwise be caused by changes in ambient radiation from outside of the apparatus 2.

Additionally a smooth surface (not shown) may optionally be provided immediately adjacent the edge of the adhesive, either within the material of the tunnel floor 12, on the card 20 itself, or as a masking membrane over the edge of the adhesive. As discussed later, the provision of such a smooth border to the adhesive serves to prevent a pest on the adhesive securing sufficient purchase on the border to effect an escape from the adhesive.

The compartment 6 houses power supply batteries and electronic circuitry (not shown) required to drive the pest detection apparatus 2 so that it may be positioned as required without the need for connection to an external power source. The apparatus is then primed by closing the lid 14, or by any other suitable means such as an activation switch or button.

The pest detection apparatus is likely to be most effective in capturing small animals of the phylum Arthropoda but may also be similarly used with other pests such as rodents.

Pests enter the tunnel section 4 from either of the open ends and can readily walk along the roughened floor 12 up to an edge 26 of the adhesive-coated card 20. The roughened floor 12 can be easily gripped by a pest as opposed to the smooth walls and ceiling of the tunnel which reduce a pest's affinity for such surfaces. Therefore upon entering the tunnel 4, a pest is discouraged from walking along any surface except for the floor 12, thereby reducing the likelihood of it evading detection and capture. In this manner the pest is effectively guided towards the adhesive.

The pest is likely to cross over one of the two edges 26 of the adhesive-coated card 20, depending upon the end of the tunnel section 4 that is entered and upon doing so, it will become stuck fast to the card 20 by way of the adhesive material. Dependent on the size of the pest, it will pass a small distance over one of the edges 26 before being inhibited from further movement. Therefore the emitter/detector pairs are positioned such that a beam 28 extending between each emitter 22 and corresponding detector 24 passes over a section of the adhesive-coated card 20, a sufficient distance away from the edge 26 that a pest breaking the beam 28 is far enough onto the adhesive to be unlikely to escape.

It is foreseeable that a pest may only become partially stuck to the adhesive, such that one or more of its legs are free to move. In this situation it is likely that the pest will attempt to free itself by pulling away from the adhesive using its loose limbs. The likelihood of a pest being successful in freeing itself can be greatly reduced by the provision of the smooth surface noted above and located immediately adjacent the edge of the adhesive, such that the pest cannot attain the grip required for this purpose.

The breaking of the beam 28 triggers the detection of the pest and the generation of a readily detectable signal provided via an LED 30 positioned in clear view on the lid 14 which can be detected by anyone located either temporarily or permanently in the vicinity of the apparatus 2. The pest is maintained on the adhesive-coated card 20 until the lid 14 is opened in order to allow for inspection. The card 20 may then be removed and disposed of along with the trapped pest. A replacement card can then be mounted within the tunnel section 4 for re-use of the apparatus.

Although an adhesive trap is described in relation to the present embodiment, the juxtaposition of different types of surface may also be used to guide a pest in order to make it particularly susceptible to detection and entrapment using a known mechanical trapping system. A mechanical trap may trigger, or may be triggered by, the detection of the pest in order to ensure that a detected pest does not avoid entrapment.

As noted, the pest detection apparatus may optionally be repositioned for further use and can be made ready again by inserting a new piece of adhesive coated card 20, closing the lid 14 and resetting the detector.

Turning now to FIG. 5 there is illustrated a perspective view of detection apparatus according to another embodiment of the present invention.

Unlike the embodiment of FIG. 1, the pest detection apparatus of FIG. 5, comprises separate detection and indication units.

That is, the detection unit 32 illustrated in FIG. 5 is merely for the purpose of detecting the presence of a pest, wherein such detection serves to provide for a signal delivered to a remote signalling unit (not shown).

Preferably the detecting unit 32 and remote signalling unit (not shown) are electrically connected by way of a cable which also serves to provide for mechanical tethering between the two units.

As described further below, the separation of the detection and indication functionality into two separate, but electrically connected, units, allows for the advantageous location of the detection unit 32 at floor level, and at a potentially inaccessible location quite likely to be attractive to the pests. The indication unit however which includes the audible and/or visible pest detection indicators, can then be disposed at a location where the visible and/or audible can be readily seen and/or heard.

The detection unit 32 as illustrated in FIG. 5 includes an elongate entrance portion 34 for pests and a security catch formation 36 allowing for opening of the unit 32 again by means of a special two-prong key.

Further details of the unit 32 of FIG. 5 are illustrated in FIG. 6.

As can be seen, FIG. 6 illustrates the embodiment of FIG. 5 but with its lid pivoted open so as to reveal the entrapment and detection features arising in relation to this further embodiment.

Disposed within the main channel running through unit 32, and leading from the entrance portion 34 is an entrapment portion in the form of an adhesive card 38. The card 38 has a region of adhesive material 42 disposed thereon and a border 40 surrounding the adhesive material. The lateral dimensions of the card 38 are greater than those of the adhesive region 42 such that the peripheral portions of the card 38 provides for the aforementioned border 40 to the adhesive material 42. Advantageously, the card 38, and thus the border 40 thereof, present a relatively smooth surface to an insect which serves to inhibit any attempt the insect might make to free itself from the adhesive region 42 and retrace its steps out of the entrance portion 34.

Also illustrated within the unit 32 is a first 44 or two 44, 48 laterally spaced elongated chambers each of which is arranged to house a relatively small printed circuit board for the mounting of the emitter/receiver pairs.

That is, chamber 44 includes a printed circuit board 46 upon which a pair of, for example, infrared emitters (not shown) are mounted. The second of the elongate chambers 48 is located adjacent the pivotal connection between the lid and base of the unit 32 and is arranged for the insertion of a printed circuit board 50 having a pair of, for example, infrared, detectors located thereon.

As will be appreciated, the pair of detectors located on the printed circuit board 50 are arranged to be aligned with the pair of emitters mounted on the printed circuit board 46 in a manner such that, in the absence of a pest, radiation emitted from each emitter is readily received by a respective one of the pair of detectors.

Also illustrated in FIG. 6 is a particularly advantageous aspect of the present invention which comprises a locating frame 52 which advantageously serves to bed and locate the entrapment portion comprising the card 38, within the unit 32. The locating frame 52 is illustrated further with reference to FIG. 7 from which it can be readily appreciated that the frame 52 comprises four leg members 54 downwardly dependent from a upper lattice portion 56.

Each of the leg members 54 can be advantageously provided as a baffle member which, as can be appreciated, is arranged to be angled and extend inwardly from the periphery of the locating frame 52 and so serves to assist in guiding pests entering the entrance portion 34 onto the adhesive material 42. Also, the locating frame 52 can be arranged to at least assist in shielding the detectors from stray radiation. Also, all of the inner surfaces of the locating frame are smooth and polished to discourage, for example, insects from seeking purchase to escape from the adhesive.

The provision of the legs 54 as baffle members advantageously allows for the ready formation of an entrapment portion 38 in the form of a card 40 having an adhesive region provided in the middle thereof 42 and where in the aforementioned frame exhibited by the card 40 allows for ready handling of the entrapment portion 38 but while maintaining the likelihood that pests entering the unit 32 will not be able to avoid passage over the adhesive material 42, for example, by means of attempted passage around the frame exhibited by the card 40.

An important aspect of the locator frame 52 is that it serves to bed and secure, the entrapment portion card 38 at an appropriate location having regard to the positions of the emitter/receiver pairs located on the printed circuit boards 50, 56. That is, it can prove important that the entrapment portion card 38 is located such the longitudinal extent of the adhesive material 42 extends beyond a detection path defined by the path between each emitter/receiver pair such that insects are only detected once they have encroached upon the adhesive material 42 to a sufficient extent to make escape unlikely.

Also, the frame locator 52 serves to bed the entrapment portion card 38 down so that the required height of the surface offered by the adhesive material 42, and relative to the height of the detection path extending between the emitter/receiver pairs, can be accurately achieved. Such height is generally determined having regard to the particular pests whose presence the unit 32 is intended to detect and so it can prove important to maintain a constant height between the entrapment portion 38 and the detection beams extending between the emitter/receiver pairs.

It should therefore be appreciated that the locator frame 52 can be readily lifted from the unit 32 so as to allow for removal of the card 38, for example, upon detection and entrapment of a pest such as an insect. In this manner, the card can be replaced by a new card 38 which can then be bedded, and accurately located, within the unit 32 by replacement of the locating frame 52. In order to achieve such accurate location, the engagement formations can advantageously be provided between the locating frame 52 and the outer surfaces of the walls defined in the chambers 44, 48.

Although not illustrated in FIG. 6, one particular advantageous arrangement for the entrapment portion 38 comprises a card having two portions separated by a fold line and wherein one of the portions is provided with an adhesive region, and the other of the portions is provided with, for example, a rectangular opening forming a window. Upon folding the card along the fold line, the aforementioned window can be arranged to expose the adhesive portion and thereby define a frame around the adhesive portion which, as before, can be formed of a material exhibiting surface characteristics making it difficult for an insect to achieve purchase. In this manner, the adhesive does not necessarily need to be applied to the card to any great degree of accuracy since the actual dimensions of the adhesive region 42 as exposed within the unit 32 are then defined by the dimensions of the aforementioned window. As an alternative, rather than folding over, the window frame could be applied as an additional and separate layer.

It should of course be appreciated that features such as the particular entrapment portion and frame locator of the embodiment of FIG. 6, can readily be included within any other embodiment of the present invention such that illustrated in relation to FIG. 1.

Also, the two-part arrangement discussed above in which the protection and indication functionality is provided in separate units ideally tethered by way of an electrical connection can be incorporated into any particular embodiment of the present invention.

Such a two-part arrangement makes it easy to locate the indication unit at a position where, for example, the LED indicator is readily visible. In one example, the indicator unit can be provided for wall mounting. The tethering between the detector unit and the indicator unit serves to enhance the security of location, and decrease the likelihood of tampering and also provide means by which the detection unit can be readily retrieved from a generally inaccessible location. Yet further, through the separation of the detecting and indicating portions, the dimensions of the detection unit such the unit 32 of FIG. 6, can be advantageously reduced so as to allow for its positioning in restricted areas. As an example, the housing unit 32 illustrated in FIG. 6 can be in the order of 10 cm long and 8 cm wide and with a height in the region of 2 cm. The on-board power supply required by the apparatus can then advantageously be located within indicator unit which also serves to allow for a reduction in size of the detector unit. A relatively large battery power supply can then be included without impacting on the reduction in size of the detection unit and so as to achieve a long service life.

In a further particular embodiment, the control electronics can be provided in the detection unit so that the indicator unit then effectively becomes a slave to the detecting unit. However, if the indicating unit includes an antenna and radio transmitter means it can further include its own control electronics which serve to control the coding and onward transmission of information as received from the detecting unit. The electronics in the detecting unit are then advantageously designed to be compatible with both the antenna, and non-antenna, versions of the indicating unit so that the different indicator units are readily interchangeable. As noted previously, the relatively small dimensions of the detecting unit mean that it can be readily placed in small restricted spaces such as under furniture and fittings, and where it is generally more likely to be encountered by pests. The indicating unit can then be located where it can be readily seen by, for example, a service technician and, if such unit includes an antenna means, it can readily be located in a position that is favourable for transmission of a radio signal to a remote receiver. When it is required to remove the detecting unit from its potentially inaccessible location, the electrical cable serving to connect the detection unit and the indicating unit, and which tethers the two units together, can readily be used to pull the detecting unit from its operational position.

The locator frame 52 such as that illustrated in FIG. 6 and FIG. 7 is advantageously formed with an upper lattice frame 56 so as to allow for ready viewing of the adhesive material region 42 once the unit 32 has been opened for inspection. Also, the edges of the legs 54 can be provided with formations and/or formed as sharp edges which serve to discourage an insect from climbing up and around each leg, while also, as mentioned, presenting relatively smooth surfaces serving to prevent an insect gaining purchase thereon. Further formations can also be included and which serve to make the locator frame 52 within the detection unit.

Yet further, and as shown in FIG. 8 additional inner walls 58 can be provided along each longitudinal side of the frame 52 and which can serve to provide additional stiffening and shielding from stray radiation. The lower edges of such walls can also serve to bed down the adhesive pad.

Of course, it should be appreciated that the present invention is not restricted to the details of the foregoing embodiments and numerous options are available for its modification. The tunnel has been described as having a rectangular cross section for illustrative purposes but may comprise any number of sides and variations of surface properties in order to encourage or discourage a pest from a particular mode/path of traversing. It is intended that the tunnel also be tapered (not shown) to improve the effectiveness of the apparatus. In order to minimise the risk of accidental or malicious triggering of the detector mechanism, the shape of the tunnel could be altered and one such embodiment might include a detector mechanism which is not accessible on a straight line path from an entrance portion. The number of emitter/detector pairs as well as their orientation relative to the adhesive coated surface can be altered to cater for particular types of pest. Visible light rather than infrared could be used for pest detection and for the source could comprise a laser light source.

Furthermore it will be clear to the skilled man that the adhesive properties of the adhesive material need not be uniform along its length and could be tailored to allow a pest to travel either greater or lesser distances over the edge of the card in order to improve the chances of detection and secure entrapment.

Whilst a currently preferred embodiment involves alerting means in the form of an activated LED or audible output, it is envisaged that upon detection of a pest, the apparatus could alternatively output a signal to either of a client or a contractor. Thus the process leading to the identification of a trapped pest could be further automated, reducing the chance of the entrapment of a pest going unnoticed.

1. Pest detection apparatus comprising;
an access portion;
an entrapment portion accessible via the access portion;
detection means for detecting the presence of a pest once in the region of the entrapment portion;
means for indicating detection of a pest by the detection means; and,
inspection means arranged to allow for viewing of a trapped pest.

2. An apparatus as claimed in claim 1, wherein the access portion is arranged to guide a pest towards the entrapment portion.

3. (canceled)

4. An apparatus as claimed in claim 1, further comprising a surface portion between the access portion and the entrapment portion, wherein a region of the surface portion is arranged to encourage a pest to traverse thereover.

5. An apparatus as claimed in claim 1, further com comprising a surface portion between the access portion and the entrapment portion, wherein a region of the surface portion is arranged to discourage a pest from traversing thereover.

6. An apparatus according to claim 1, wherein the access portion leads to a tunnel member, such that at least one region of the tunnel member has a relatively roughened texture and at least one further section of the tunnel member has a relatively smooth texture.

7. An apparatus according to claim 1, wherein the entrapment portion comprises an adhesive material provided as an adhesive coated surface.

8. An apparatus according to claim 7, wherein the adhesive material is removably and replaceably positioned within the access portion.

9-10. (canceled)

11. An apparatus according to claim 1, wherein the entrapment portion comprises a mechanical trap.

12. (canceled)

13. An apparatus according to claim 1, wherein the detection means comprises at least one emitter/detector pair arranged such that a radiation beam extending between each emitter/detector is broken by a pest.

14. An apparatus as claimed in claim 13, wherein the at least one emitter/detector pair is mounted relative to the entrapment portion such that a pest is detected once the pest has passed over an edge of the entrapment portion.

15. (canceled)

16. An apparatus according to claim 1, wherein the means for indicating the detection of a pest by the detection means is arranged for generation of an audible and/or visible signal.

17. An apparatus according to claim 1, wherein the means for indicating the detection of a pest by the detection means is arranged to transmit a data signal to a remote location.

18-19. (canceled)

20. Apparatus as claimed in claim 1 wherein the detection means and the means for indicating detection are provided in separate housings.

21-25. (canceled)

26. Apparatus as claimed in claim 1, and including a removable locating frame member for engaging the entrapment portion within the apparatus.

27. (canceled)

28. Apparatus as claimed in claim 26, wherein the locating frame includes a plurality of downwardly depending leg members arranged to engage the entrapment portion.

29. Apparatus as claimed in claim 28 wherein said leg members are arranged to guide a pest to the adhesive material on the entrapment portion.

30-32. (canceled)

33. Apparatus as claimed in claim 21 wherein the entrapment portion comprises a flat foldable member in which a first portion is foldable relative to a second portion.

34. Apparatus as claimed in claim 33, wherein the adhesive material is provided on a first portion, and a window is formed within the second portion such that when the second portion is folded onto the first portion, the adhesive material is exposed through the said window.

35-36. (canceled)

37. An apparatus according to claim 1 wherein the apparatus comprises an enclosure structure having a tunnel portion forming at least the entrapment portion and a housing portion for housing electronic circuitry, and which is arranged such that a lid member covers at least the tunnel region when disposed in a closed position and exposes at least the tunnel portion when disposed in an open position.

38. A pest entrapment member for use within pest monitoring apparatus comprising a flat member having first and second portions separated by a fold line allowing for folding of the second portion onto the first portion, wherein the first portion is provided with an adhesive material, and the second portion is provided with a window such that, upon folding of the second portion onto the first portion, the adhesive material is exposed via the said window.

39-42. (canceled)
